(19) United States
(12) Patent Application Publication
(10) Pub. No.: US 2024/0006896 A1
(43) Pub. Date: Jan. 4, 2024

(54) ELECTRONIC DEVICE POWERING

(71) Applicants: STMicroelectronics (Rousset) SAS, Rousset Cedex (FR); STMicroelectronics (Alps) SAS, Grenoble (FR)

(72) Inventors: Patrick Arnould, Voreppe (FR); Alexandre Tramoni, Le Beausset (FR)

(21) Appl. No.: 18/346,494

(22) Filed: Jul. 3, 2023

(30) Foreign Application Priority Data
Jul. 4, 2022 (FR) 2206729

(51) Int. Cl. H02J 7/00

(52) U.S. Cl. CPC H02J 7/0031; H02J 7/0063

(57) ABSTRACT

In accordance with an embodiment, a circuit for managing a power supply of an electronic module includes: a first state machine configured to receive a first command for disabling the module, and to verify that the first command remains the same for a first minimum time period; and a second state machine configured to cut off a power supply of a first portion of the module when the second state machine receives a second command from the first state machine indicating that the first command has remained the same for the first minimum time period. The first portion of the module is configured to is configured to be powered from a battery via a first power supply voltage.

### CROSS-REFERENCE TO RELATED APPLICATIONS

This application claims the priority benefit of French Patent Application No. 2206729, filed on Jul. 4, 2022, which is hereby incorporated by reference to the maximum extent allowable by law.

### TECHNICAL FIELD

The present disclosure generally concerns electronic systems and devices, and the power supply of these systems and devices.

### BACKGROUND

The most complex electronic devices, such as computers, smart phones, and tablet computers currently have a multitude of functionalities capable of being implemented by different modules and circuits comprised in these devices.

The management of the power supply of these circuits and modules becomes more and more complex as new functionalities are added.

It would be desirable to be able to at least partly improve certain aspects of known electronic devices, and more particularly of their power supply management.

### SUMMARY

An embodiment provides a circuit for managing the power supply of an electronic module comprising:
a first state machine configurable to receive a first command for disabling the module, and to verify that the first command remains the same for a first minimum time period; and
a second state machine configured to cut off the power supply of at least a first portion of the module when the second state machine receives a second command from the first state machine indicating that the first command has remained the same for a first minimum time period,
the at least a first portion of the module being powered with a first power supply voltage from a battery.

Another embodiment provides a method of powering an electronic module comprising a circuit for managing the power supply of an electronic module comprising:
a first state machine configurable to receive a first command for disabling the module, and to verify that the first command remains the same for a first minimum time period; and
a second state machine configured to cut off the power supply of at least a first portion of the module when the second state machine receives a second command from the first state machine indicating that the first command has remained the same for a first minimum time period,
the at least a first portion of the module being powered with a first power supply voltage from a battery.

According to an embodiment, the first disable command corresponds to a first state of a first signal for controlling the module.

According to an embodiment, the first control signal is obtained from a second signal for controlling the module and from a third signal indicating the state of a second power supply voltage of the module.

According to an embodiment, when the first control signal switches to the first state, the first state machine is configured to count the time for which the first signal remains in this first state.

According to an embodiment, on reception of the second command, the second state machine is configured to electrically isolate the first portion of the module from other circuits.

According to an embodiment, on reception of the second command, the second state machine is configured to let operate the power supply of at least a second portion of the module, distinct from the first portion.

According to an embodiment, the first state machine is configured to deliver the second command whatever the operating state of the first module.

According to an embodiment, the management circuit further comprises a wake-up circuit configured to boot the module on reception of a third boot command.

According to an embodiment, the third boot command is generated when the first signal for controlling the module switches to a second state, different from the first state.

Another embodiment provides an electronic module comprising a previously-described power management circuit.

According to an embodiment, the electronic module is a secure element.

According to an embodiment, the electronic module is configured to implement a near-field communication.

Another embodiment provides an electronic device comprising a battery and a previously-described electronic module.

### BRIEF DESCRIPTION OF THE DRAWINGS

The foregoing features and advantages, as well as others, will be described in detail in the rest of the disclosure of specific embodiments given by way of illustration and not limitation with reference to the accompanying drawings, in which:

FIG. 1 very schematically shows in the form of blocks an example of an electronic device;

FIG. 2 very schematically shows in the form of blocks the different states of a circuit or module of the device of FIG. 1;

FIG. 3 very schematically shows in the form of blocks an embodiment of an electronic device;

FIG. 4 very schematically shows in the form of blocks an embodiment of a power supply management circuit comprised in the embodiment of FIG. 3;

FIG. 5 shows a block diagram illustrating the operation of the device of FIG. 3;

FIG. 6 shows timing diagrams illustrating the operation of the device of FIG. 3; and

FIG. 7 shows other timing diagrams illustrating the operation of the device of FIG. 3.

### DETAILED DESCRIPTION OF ILLUSTRATIVE EMBODIMENTS

Like features have been designated by like references in the various figures. In particular, the structural and/or functional features that are common among the various embodiments may have the same references and may dispose identical structural, dimensional and material properties.

For the sake of clarity, only the steps and elements that are useful for an understanding of the embodiments described herein have been illustrated and described in detail. In particular, the details of the circuits of the embodiments described hereafter are not entirely described and are within the abilities of those skilled in the art.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, when reference is made to absolute positional qualifiers, such as the terms “front”, “back”, “top”, “bottom”, “left”, “right”, etc., or to relative positional qualifiers, such as the terms “above”, “below”, “upper”, “lower”, etc., or to qualifiers of orientation, such as “horizontal”, “vertical”, etc., reference is made, unless specified otherwise, to the orientation of the figures.

Unless specified otherwise, the expressions “around”, “approximately”, “substantially” and “in the order of” signify within 10%, and preferably within 5%.

Some embodiments are directed to electronic devices that reliably manage their power supply, for example, to consume less energy.

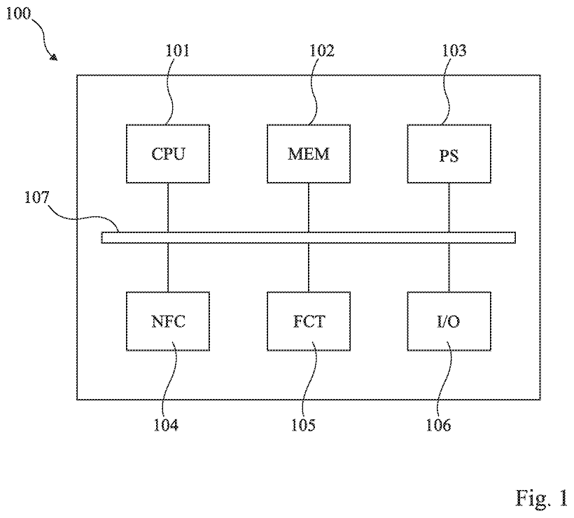

FIG. 1 very schematically shows in the form of blocks an example of an electronic device 100.

Electronic device 100 comprises a processor 101 (CPU) adapted to implement different types of processing of data stored in memories and/or delivered by other circuits and/or modules of device 100.

Electronic device 100 further comprises different types of memories 102 (MEM), among which, for example, a ROM, a volatile memory, and/or a non-volatile memory. Each memory is adapted to storing different types of data.

Electronic device 100 further comprises power supply circuits 103 (PS). Circuits 103 manage the electric power supply of the different circuits and modules of device 100. Circuits 103 for example comprise a battery, battery charge means, voltage adaption circuits, such as voltage regulators, etc.

Electronic device 100 may further comprise circuits 104 (NFC) adapted to implement a near-field communication, or near-field communication module 104, or NFC module 104. NFC module 104 for example comprises oscillating/resonating circuits, data transmission and reception circuits, data conversion circuits, power supply control circuits, etc.

Electronic device 100 further comprises circuits or modules 105 (FCT) adapted to implementing different functions of device 105. Circuits 35 are varied, and may comprise measurement circuits, data analysis circuits, sensors, etc. According to an example, circuits or modules 105 may comprise a secure element adapted to managing critical data, or secret data.

Electronic device 100 further comprises input and output circuits 106 (I/O) of device 100. Circuits 106 for example comprise connectors enabling device 100 to transmit and to receive data, display devices, etc.

Electronic device 100 further comprises one or a plurality of communication buses 107 adapted to coupling two, or more than two, circuits or modules of device 100 together. A single bus 107 is shown in FIG. 1. Bus(es) 100 may enable transferring data and/or instruction signals, but also energy between two or more than two circuits or modules of device 100.

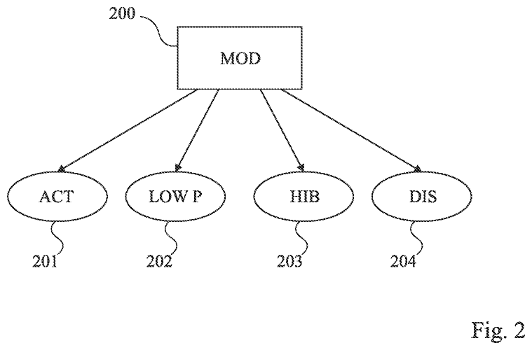

FIG. 2 very schematically shows in the form of blocks a module 200 of the device 100 described in relation with FIG. 1 and its different operating modes.

Module 200 may be different modules or circuits of device loft According to an example, module 200 is an NFC module of the type of the module 104 described in relation with FIG. 1. According to another example, module 200 is one of the circuits 105 described in relation with FIG. 1. According to an example, module 200 is one of the circuits 106 described in relation with FIG. 1.

Module 200 has a plurality of operating modes, each having a different power supply mode.

A first operating mode of module 200 is the active mode 201 (ACT), or full power mode, where module 200 is powered to be able to implement all its functionalities, in other words, all the circuits and components of module 200 are likely to be powered to be operating. It is during this operating mode that the power consumption of module 200 is likely to be maximum.

A second operating mode of module 200 is the low power consumption mode 202 (low P), where module 200 is only powered to implement a small number of functionalities, so as to save energy. In other words, during this operating mode, all the circuits and components of the module cannot be powered at the same time. According to another example, during this mode, the clock frequencies of the processor(s) of module 200 are decreased. According to an example, module 200 may comprise a plurality of different low power consumption modes enabling to implement different functionalities of module 200.

A third operating mode of module 200 is the very low power consumption mode 203 (HIB), or hibernation mode, where module 200 is only powered to implement a very small number of functionalities. Very low power consumption mode 203 is a variant of low power consumption mode 202. During this mode, module 200 decreases its power consumption as much as possible by only implementing a very small number of functionalities. According to an example, during this operating mode, the module only implements the functionalities enabling it to “wake up”, that is, only the functionalities enabling it to switch to another operating mode. According to another example, during this operating mode, the module only implements the functionalities enabling it to “wake up” and functionalities consuming very little energy.

A fourth operating mode of module 200 is the disabled mode 204 (DIS), or disabled mode, where module 200 is only powered to implement a very small number of functionalities, all its main functionalities being disabled as compared with the very low power consumption mode, and can implement none of its functionalities except for the functionalities enabling it to “wake up.” In practice, during disabled mode 204, module 200 is disconnected from its energy source, the battery of device 100 for example. According to a variant, if module 200 is used as an intermediate to power other circuits or modules, then this functionality may be kept during the disabled mode.

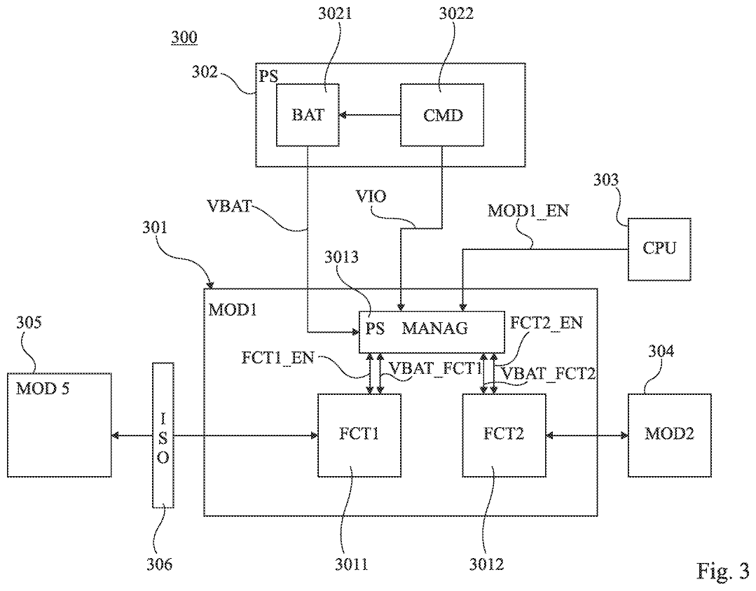

FIG. 3 very schematically shows in the form of blocks an embodiment of an electronic device 300 of the type of the device 100 described in relation with FIG. 1, comprising an embodiment of an electronic module 301 (MOD1) of the type of the module 200 described in relation with FIG. 2.

Only a portion of device 300 is shown in FIG. 3. This portion comprises:
module 301;
a power supply circuit 302;
a processor 303;
two electronic modules 304 (MOD2) and 305 (MOD5); and an electrical isolation circuit 306 (ISO).

Power supply circuit 302 comprises a battery 3021 (BAT) and a control circuit 3022 (CMD). The power supply module delivers power supply voltages to the different modules of device 300 via control circuit 3022 or directly from the battery. More particularly, battery 3021 directly delivers a power supply voltage VBAT, and control circuit 3022 delivers, via a power supply rail, at least one input/output power supply voltage VIO. Voltage VIO is a power supply voltage having its state depending on the operating state of device 300. According to an example, when device 300 is off, voltage VIO is in a low state.

As previously mentioned, module 301 is of the type of the module 200 described in relation with FIG. 2. According to an embodiment, module 301 is adapted to implementing at least one functionality, for example two functionalities in the case of FIG. 3. Further, according to an embodiment, module 301 directly receives power supply voltage VBAT from the battery 3021 of power supply circuit 302, without for control circuits 3022 to be used as an intermediate. Module 301 further receives, via a power supply rail, input/output power supply voltage VIO. Thus, module 301 comprises:
first circuits 3011 (FCT1) implementing a first functionality;
second circuits 3012 (FCT2) implementing a second functionality; and
a power supply management circuit 3013 (PS MANAG).

According to an embodiment, the first functionality is the main functionality of module 301, and when module 301 is in a disabled mode, of the type of the mode 204 described in relation with FIG. 2, the first functionality is not powered. First circuits 3011 receive, from circuit 3013, a power supply voltage VBAT_FCT1 and a control signal FCT1_EN.

Further, and according to an example, the first functionality is adapted to exchanging data and/or energy with one or a plurality of modules of device 300, for example module 305 in FIG. 3. When module 301 is in a disabled mode, module 301, and more particularly circuits 3011, are electrically isolated from module 305 via isolation circuit 306. Thus, when module 301 is in a disabled mode, the first functionality is not powered, and isolation circuit 306 is activated.

According to an example, the second functionality is an auxiliary functionality of module 301, and when module 301 is in a disabled mode, of the type of the mode 204 described in relation with FIG. 2, the second functionality is still powered. Second circuits 3012 receive, from circuit 3013, a power supply voltage VBAT FCT2 and a control signal FCT2_EN. According to an embodiment, the second functionality may enable powering one or a plurality of other modules or circuits of device 300 with energy. In FIG. 3, the second functionality exchanges data and/or energy with module 304.

According to an embodiment, power supply management circuit 3013 directly receives a power supply voltage VBAT from the battery 3021 of power supply circuit 302 and voltage VIO from the control circuit 3022 of power supply circuit 302. Circuit 3013 further receives a signal MOD1_EN for controlling module 301 from, for example, processor 303. Control signal MOD1_EN is a signal for enabling module 301 and more particularly enables the disabling of module 301. In other words, when the enable signal is in a first state, for example, a high state, module 301 is active, in a low power consumption mode or in a very low power consumption mode, such as the modes 201, 202, or 203 described in relation with FIG. 2, and when the enable signal is in a second state, for example a low state, module 301 enters the disabled mode, of type of the mode 204 described in relation with FIG. 2, whatever the operating mode in which module 301 previously was. Circuit 3013 thus enables managing the power supply of the different functionalities of module 301 according to the state of control signal MOD1_EN.

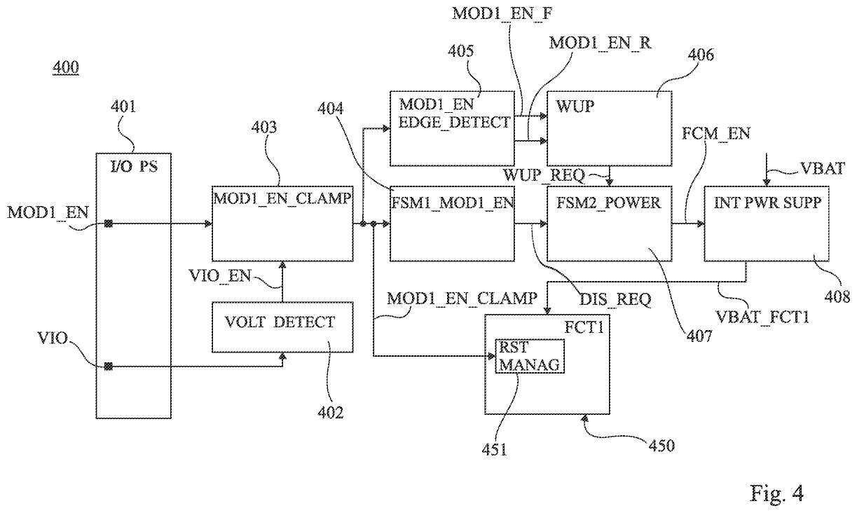

Further, the communication bus transmitting control signal MOD1_EN is powered with power supply voltage VIO. If power supply voltage VIO is no longer capable of powering control signal MOD1_EN, for example if power supply voltage VIO is in a low state, then control signal MOD1_EN also is in a low state. Power supply management circuit 3013 may comprise one or a plurality of circuits enabling to differentiate a low state of signal MOD1_EN resulting from a command or from a low state of power supply voltage VIO. Such a circuit is described in relation with FIG. 4.

An example of embodiment of circuit 3013 and its operation is detailed in relation with FIGS. 4 to 7.

FIG. 4 very schematically shows in the form of blocks a circuit 400 of the type of the circuit 3013 described in relation with FIG. 3, and circuits 450 (FCT) of the type of the circuits 3011 described in relation with FIG. 3.

As described in relation with FIG. 3, circuit 400 is a circuit for managing the power supply of an electronic module of an electronic device. This electronic module receives a power supply voltage VBAT delivered by a battery, and an input/output power supply voltage VIO delivered by a control circuit of a power supply circuit. Voltages VBAT and VIO are identical to the voltages VBAT and VIO described in relation with FIG. 3. Further, the electronic module is adapted to receiving the control signal MOD1_EN described in relation with FIG. 3. In the example of FIG. 4, control signal MOD1_EN comprises two states, among which:
a high state indicating that the module comprising circuit 400 is in an active mode, a low power consumption mode, or a very low power consumption mode; and
a low state indicating that the module comprising circuit 400 is in a disabled state, or indicating that power supply voltage VIO is not able to power the communication bus delivering voltage MOD1_EN.

Those skilled in the art will be capable of adapting circuit 400 with a control signal MOD1_EN comprising the two following states:
a low state indicating that the module comprising circuit 400 is in an active mode, a low power consumption mode, or a very low power consumption mode; and
a high state indicating that the module comprising circuit 400 is in a disabled state, or indicating that power supply voltage VIO is not able to power the communication bus delivering voltage MOD1_EN.

Circuit 400 comprises a connection rail 401 (I/O PS) receiving power supply voltage VIO and control signal MOD1_EN. Connection rail 401 is powered with the power supply voltage VIO delivered by the power supply rail of the power supply circuit of the electronic device comprising the module comprising circuit 400.

Circuit 400 further comprises a voltage detector circuit 402 (VOLT DETECT) adapted to detecting the presence or not of power supply voltage VIO. For this purpose, a circuit 402 receives power supply voltage VIO and outputs an information signal VIO_EN indicating by a first state that power supply voltage VIO is present, or is sufficiently high to power connection rail 401, and thus the module comprising circuit 400, and by a second state that power supply voltage VIO is not present or is not sufficiently high to power connection rail 401.

Circuit 400 further comprises a circuit 403 (MOD1_EN_CLAMP) adapted to verifying the state of control signal MOD1_EN according to the state of signal VIO_EN. For this purpose, circuit 403 receives signals MOD1_EN and VIO_EN, and outputs an information signal MOD1_EN_CLAMP. Information signal MOD1_EN_CLAMP comprises a high state indicating that the module comprising circuit 400 receives a power supply voltage VIO and is in an active mode, a low power consumption mode, or a very low power consumption mode. Information signal MOD1_EN_CLAMP further comprises a low state indicating that the module is in a disabled mode and/or receives no power supply voltage VIO. Circuit 403 may further enable determining whether signal MOD1_EN is in a low state because power supply voltage VIO is in a low state or whether signal MOD1_EN is in a low state due to the sending of a command from the processor.

Circuit 400 further comprises a first state machine 404 (FSM1_MOD1_EN) receiving information signal MOD1_EN_CLAMP and outputting a request signal DIS_REQ. State machine 404 has the role of verifying that a request originating from the processor to switch the module to a disabled state has a sufficiently long duration. In other words, state machine 404 verifies that after its switching to a low state, signal MOD1_EN_CLAMP remains in this low state for a sufficiently long time, that is, at least for a minimum time period. For this purpose, at each falling edge of signal MOD1_EN_CLAMP, state machine 404 starts a counter. If the value of this counter exceeds a threshold value without for signal MOD1_EN_CLAMP to have exhibited a rising edge, that is, without for signal MOD1_EN to exhibit a rising edge or without for signal VIO_EN to exhibit a falling edge, then the module has to be switched to a disabled mode. Conversely, if signal MOD1_EN_CLAMP exhibits a rising edge, that is, if one signals MOD1_EN and VIO_EN has exhibited a rising or falling edge before the value of the counter reaches the threshold value, then the module must not switch to a disabled mode. The advantage of this state machine is that it enables avoiding “false” commands that enable switching the module to a disabled mode. The signal DIS_REQ supplied by the state machine indicates whether the module has to be switched to a disabled mode or not.

Circuit 400 further comprises an edge detection circuit 405 (MOD1_EN EDGE DETECT) receiving signal MOD1_EN_CLAMP, and delivering as an output alert signals indicating a rising edge MOD1_EN R and a falling edge MOD1_EN F.

Circuit 400 further comprises a wake-up circuit 406 (WUP) receiving rising edge and falling edge alert signals MOD1_EN R and MOD1_EN F and delivering as an output a wake-up signal WUP_REQ. Circuit 406 enables sending a wake-up command each time signal MOD1_EN_CLAMP exhibits a rising or falling edge.

Circuit 400 further comprises a second state machine 407 receiving signals DIS_REQ and WUP_REQ and delivering signal FCT1_EN. State machine 407 is made active by wake-up signal WUP_REQ. State machine 407 is used to start or stop the power supply of the module according to the command transmitted by signal DIS_REQ. State machine 407 is further used to boot or stop the electronic device isolation circuit(s).

Eventually, circuit 40o further comprises a power supply circuit 408 (INT PWR SUPP) adapted to delivering the battery power supply voltage VBAT to circuits 450 if state machine 407 asks for it, or to stop the power supply with power supply voltage VBAT. For this purpose, circuit 408 delivers voltage VBAT and signal FCT1_EN, and outputs signal VBAT_FCT1. Circuit 40o may for example comprise regulators enabling to adapt the amplitude of voltage VBAT.

Circuits 450 may comprise a reset circuit 451 receiving signal MOD1_EN_CLAMP.

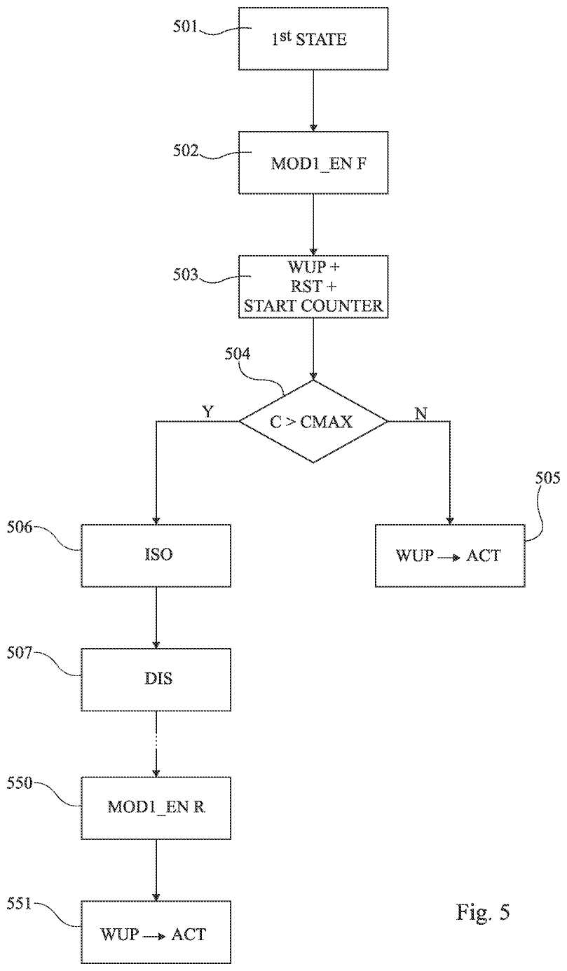

FIG. 5 shows a block diagram illustrating the operation of the circuit 400 described in relation with FIG. 4. More particularly, FIG. 5 illustrates the operation of circuit 400 when the module which comprises it switches from an active mode, from a low power consumption mode or from a very low power consumption mode, to a disabled mode. FIG. 5 further illustrates the operation of circuit 400 when the module switches from a disabled mode to an active mode, a low power consumption mode, or a very low power consumption mode.

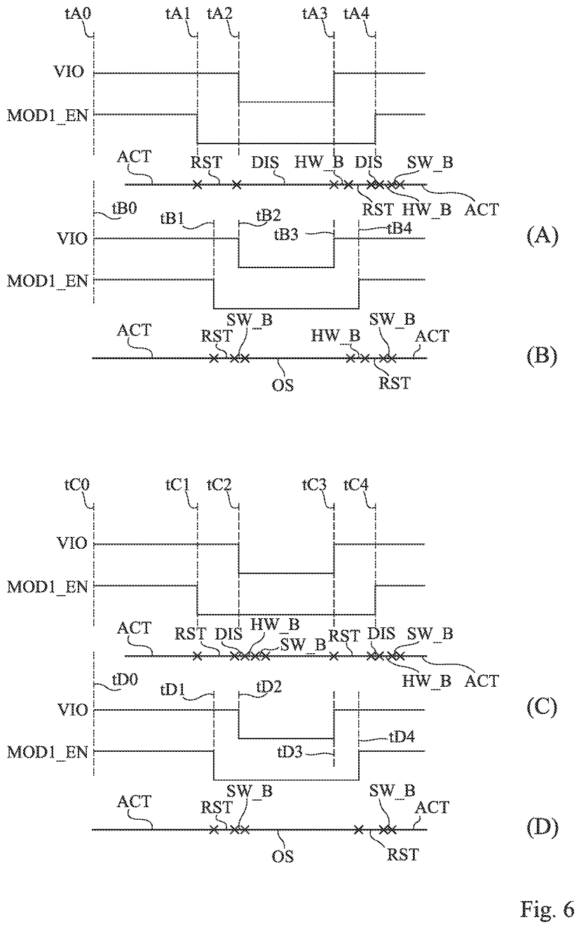

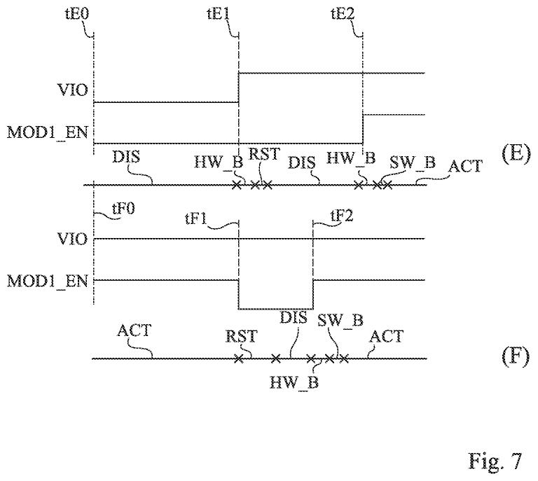

It should be noted that in FIG. 5, power supply voltage VIO remains in a high state. The cases where power supply voltage VIO switches to a low state are described in relation with FIGS. 6 and 7.

At an initial step 501 (1st STATE), the module is in an active mode, a low power consumption mode, or a very low power consumption mode, that is, a mode where at least a portion of the circuits and/or of the functionalities of the module is powered. Control signal MOD1_EN is in a high state.

At a step 502 (MOD1_EN F), control signal MOD1_EN exhibits a falling edge, and thus switches from the high state to the low state. In other words, the processor, or the circuit delivering control signal MOD1_EN, indicates that the module has to switch to a disabled state. It is assumed that voltage VIO is present.

At a step 503 (WUP+RST+START COUNTER), circuit 403 delivers a signal MOD1_EN_CLAMP exhibiting a falling edge to circuit 405, to state machine 404, and to the circuit 451 for resetting circuits 450.

Circuit 405 detects this falling edge and informs circuit 406 thereof via signal MOD1_EN F. Circuit 406 then sends a wake-up request, via signal WUP_REQ, to state machine FSM2_POVVER. According to an example, circuit 406 may also send this wake-up request to other circuits of the device comprising the module.

State machine 404 receives signal MOD1_EN_CLAMP and starts the counter at the time of the occurrence of the falling edge. The value C of the counter increases as long as signal MOD1_EN_CLAMP exhibits not falling edge.

Reset circuit 451 receives signal MOD1_EN_CLAMP and, according to an example, starts the resetting of the functionality implemented by circuits 450.

At a step 504 (C>CMAX), if signal MOD1_EN_CLAMP exhibits a rising edge, that is, if signal MOD1_EN exhibits a rising edge or if signal VIO_EN exhibits a falling edge, before value C exceeds a threshold value CMAX (output N), then the next step is a step 505 (WUP->ACT). Conversely, if the value C of the counter of state machine 404 exceeds threshold value CMAX without for signal MOD1_EN_CLAMP to exhibit a rising edge, that is, without for signal MOD1_EN to exhibit a rising edge or without for signal VIO_EN to exhibit a falling edge (output Y), then the next step is a step 5o6 (ISO).

At step 505, signal MOD1_EN_CLAMP has not remained in a low state for a sufficiently long time for the command for switching to a disabled mode to be taken into account. Circuit 405 detects the rising edge of signal MOD1_EN_CLAMP and informs circuit 406 thereof, via signal MOD1_EN R, which then takes care of waking up the useful circuits of the module.

At step 506, signal MOD1_EN_CLAMP has remained in a low state for a sufficiently long time for the command for switching to a disabled mode to be taken into account. State machine 404 sends a request for setting to the disabled mode, via signal DIS_REQ, to state machine 407.

At a step 507 (DIS), state machine 407 receives the request and cuts off the power supply of circuits 450. For this purpose, the state machine 407 generates signal FCT1_EN and sends it to circuit 408. According to an example, state machine 407 is adapted to delivering a signal of the type of signal FCT1_EN for each functionality implemented by the module. If a functionality, of the type of the second functionality of circuits 3012, has to remain powered during the disabled mode, state machine 407 requests it from circuit 408.

At a step 550 (MOD1_EN R), the module has remained in a disabled more for some time, and receives a command for switching to an active mode, a low power consumption mode, or a very low power consumption mode. In other words, signal MOD1_EN has remained in a state for some time, and exhibits, at the time of step 550, a rising edge. It is still assumed that voltage VIO is still present.

At a step 551 (WUP->ACT), the module has entered an active state. Since voltage VIO is present, signal MOD1_EN_CLAMP also exhibits a rising edge which is detected by circuit 405. Wake-up circuit 406 receives the information and then wakes up state machine 407 and all the circuits useful for the booting of the module.

FIGS. 6 and 7 comprise 6 timing diagrams (A), (B), (C), (D), (E), and (F) illustrating more precise examples of operation of the module comprising circuit 400, and in particular the different hardware and software steps implemented during the transition from an active mode to a disabled mode.

It is considered that the module comprises different states, among which:
the active state ACT corresponding to the active mode of the module, or to a low power consumption mode, or a very low power consumption mode of the module;
the hardware boot state HW_B during which the module boots its circuits and components;
the software boot state SW_B during which the module boots the software that it implements;
the reset state RST during which the module is rebooted;
the disabled state DIS corresponding to the disabled mode of the module.

Each timing diagram (A), (B), (C), (D), (E), and (F) comprises a curve representing the time variation of input/output power supply voltage VIO, a curve representing the time variation of signal MOD1_EN, or voltage MOD1_EN, and an axis illustrating the different states of the module during the variation of voltages VIO and MOD1_EN.

Timing diagram (A) illustrates the case where a disable request, that is, a request for switching to the disabled mode, is sent to the module. Further, timing diagram (A) illustrates the case where the disable request is sufficiently long to be taken into account.

At an initial time tA0, the module is in an active state ACT and voltages VIO and

MOD1_EN are both in a high state.

At a time tA1, subsequent to time tA0, signal MOD1_EN exhibits a falling edge and switches to a low state. Voltage VIO remains in a high state. Circuit 451 for resetting the circuits 450 of the module are booted and reset the functionality of circuits 450 as previously described. The module then is in reset state RST. During this state RST, state machine 404 starts its counter. In the case of timing diagram (A), the value C of the counter exceeds threshold value CMAX, the module thus switches to disabled state DIS.

At a time tA2, subsequent to time tA1, voltage VIO exhibits a falling edge, and switches to a low state. Signal MOD1_EN remains in a low state. The module is still in the disabled mode.

At a time tA3, subsequent to time tA2, voltage VIO exhibits a rising edge, and switches to a high state. Signal MOD1_EN remains in a low state. The module switches from disabled state DIS to hardware boot state HW_B. At the end of state HW_B, the circuits of the module are booted, in particular state machine 404 is booted and detects that signal MOD1_EN is still in the low state. State machine 404 then starts its counter, and the module switches back to reset state RST. The value C of the counter exceeds again threshold value CMAX, the module thus switches to disabled state DIS.

At a time tA4, subsequent to time tA3, signal MOD1_EN exhibits a rising edge, and switches to a high state. Voltage VIO remains in a high state. The module switches to hardware boot state HW_B, then to the software boot state, and finally to the active state.

Timing diagram (B) illustrates the case where a disable request, that is, a request for switching to the disabled mode, is sent to the module. Further, timing diagram (B) illustrates the case where the disable request is not sufficiently long to be taken into account.

At an initial time tB0, the module is in an active state ACT and voltages VIO and

MOD1_EN are both in a high state.

At a time tB1, subsequent to time tB0, signal MOD1_EN exhibits a falling edge, and switches to a low state. Voltage VIO remains in a high state. As previously described, the module then is in reset state RST. During this state RST, state machine 404 starts its counter. In the case of timing diagram (B), the value C of the counter does not reach threshold value CMAX.

At a time tB2, subsequent to time tB1, voltage VIO exhibits a falling edge, and switches to a low state. Signal MOD1_EN remains in a low state. The module then switches to a software boot state, then when its software has booted, to a state to be defined OS. Here, the software of the module, and also of the device comprising the module, defines what may happen.

At a time tB3, subsequent to time tB2, voltage VIO exhibits a rising edge, and switches to a high state. Signal MOD1_EN remains in a low state. The module switches from disabled state DIS to hardware boot state HW_B. At the end of state HW_B, the circuits of the module are booted, in particular, state machine 404 is booted and detects that signal MOD1_EN is still in the low state. State machine 404 then starts its counter, and the module switches back to reset state RST. The value C of the counter does not reach threshold value CMAX.

At a time tB4, subsequent to time tB3, signal MOD1_EN exhibits a rising edge, and switches to a high state. Voltage VIO remains in a high state. The module switches to the software boot state SW_B, then to the active state.

Timing diagram (C) illustrates a variant of the case of timing diagram (A), where a disable request, that is, a request for switching to the disabled state, is sent to the module since the power supply rail delivering power supply voltage VIO is turning off. Further, timing diagram (C) illustrates the case where the disable request is sufficiently long to be taken into account.

At an initial time tC0, the module is in an active state ACT and voltages VIO and

MOD1_EN are both in a high state.

At a time tC1, subsequent to state tC0, signal MOD1_EN exhibits a falling edge, and switches to a low state. Voltage VIO remains in a high state. As previously described, the module then is in reset state RST. During this state RST, state machine 404 starts its counter. In the case of timing diagram (C), the value C of the counter exceeds threshold value CMAX, the module thus switches to disabled state DIS.

At a time tC2, subsequent to state tC1, voltage VIO exhibits a falling edge, and switches to a low state. Signal MOD1_EN remains in a low state. As detected by circuit 403, signal MOD1_EN is in a low state because the power supply voltage is in a low state and not because the processor asks the module to switch to a disabled state. Circuit 403 thus deduces that circuits 450 have to be rebooted. The module thus switches to the hardware boot state HW_B, then to the software boot state SW_B, and finally to a software state to be defined OS, for example, a low power consumption mode or a very low power consumption mode.

At a time tC3, subsequent to state tC2, voltage VIO exhibits a rising edge, and switches to a high state. Signal MOD1_EN remains in a low state. The circuits of the module being booted, state machine 404 detects that signal MOD1_EN is still in the low state. State machine 404 then starts its counter, and the module switches back to reset state RST. The value C of the counter exceeds, for example threshold value CMAX, the module thus switches to disabled state DIS.

At a time tC4, subsequent to state tC3, signal MOD1_EN exhibits a rising edge, and switches to a high state. Voltage VIO remains in a high state. The module switches to hardware boot state HW_B, then to the software boot state, and finally to the active state.

Timing diagram (D) illustrates a variant of the case of timing diagram (B), where a disable request, that is, a request for switching to the disabled state, is sent to the module because the power supply rail delivering power supply voltage VIO is turning off. Further, timing diagram (D) illustrates the case where the disable request is not sufficiently long to be taken into account.

At an initial time tD0, the module is in an active state ACT and voltages VIO and

MOD1_EN are both in a high state.

At a time tD1, subsequent to time tD0, signal MOD1_EN exhibits a falling edge, and switches to a low state. Voltage VIO remains in a high state. As previously described, the module then is in reset state RST. During this state RST, state machine 404 starts its counter. In the case of timing diagram (D), the value C of the counter does not reach value CMAX.

At a time tD2, subsequent to time tD1, voltage VIO exhibits a falling edge, and switches to a low state. Signal MOD1_EN remains in a low state. The module then switches to a software boot state, then when its software has booted, to a state to be defined OS.

At a time tD3, subsequent to state tD2, voltage VIO exhibits a rising edge, and switches to a high state. Signal MOD1_EN remains in a low state. The module switches from disabled state DIS to hardware boot state HW_B. At the end of state HW_B, the circuits of the module are booted, in particular, state machine 404 is booted and detects that signal MOD1_EN is still in the low state. State machine 404 then boots its counter, and the module switches back to reset state RST. The value C of the counter does not reach threshold CMAX.

At a time tD4, subsequent to time tD3, signal MOD1_EN exhibits a rising edge, and switches to a high state. Voltage VIO remains in a high state. The module switches to software boot state SW_B, then to the active state.

Timing diagram (E) illustrates a boot sequence of the module, that is, the booting of power supply VIO, then the switching from a disabled state to an active state.

At an initial time tE0, voltage VIO and signal MOD1_EN are in a low state. The module is in a disabled state DIS.

At a time tE1, subsequent to time tE0, voltage VIO exhibits a rising edge, and switches to a high state. Signal MOD1_EN remains in a low state. The module switches to a hardware boot state HW_B. At the end of state HW_B, the circuits of the module are booted, in particular, state machine 404 is booted and detects that signal MOD1_EN is still in the low state. State machine 404 then starts its counter, and the module switches back to reset state RST. The value C of the counter does not reach threshold value CMAX, and the module switches to a disabled state DIS.

At a time tE2, subsequent to time tE1, signal MOD1_EN exhibits a rising edge, and switches to a high state. Voltage VIO remains in a high state. The module may boot, it then switches to hardware boot state HW_B, then to the software boot state, and finally to the active state.

Timing diagram (F) illustrates a module reset sequence, that is, the switching from an active state ACT to a disabled state DIS, then to an active state ACT.

At an initial time tF0, voltage VIO and signal MOD1_EN are in a high state. The module is in an active state ACT.

At a time tF1, subsequent to state tF0, signal MOD1_EN exhibits a falling edge, and switches to a low state. Voltage VIO remains in a high state. The circuit 451 for resetting the circuits 450 of the module boots and resets the functionality of circuits 450 as previously described in relation with FIGS. 4 and 5. The module then is in reset state RST. During this state RST, state machine 404 starts its counter. In the case of timing diagram (F), the value C of the counter exceeds threshold value CMAX, the module thus switches to disabled state DIS.

At a time tF2, subsequent to time tF1, signal MOD1_EN exhibits a rising edge, and switches to a high state. Voltage VIO remains in a high state. The module may boot, it then switches to hardware boot state HW_B, then to software boot state SW_B, and finally to active state ACT.

Various embodiments and variants have been described. Those skilled in the art will understand that certain features of these various embodiments and variants may be combined, and other variants will occur to those skilled in the art.

Finally, the practical implementation of the described embodiments and variations is within the abilities of those skilled in the art based on the functional indications given hereinabove.

What is claimed is:

1. A circuit for managing a power supply of an electronic module, the circuit comprising:
a first state machine configured to receive a first command for disabling the module, and to verify that the first command remains the same for a first minimum time period; and
a second state machine configured to cut off the power supply to a first portion of the module when the second state machine receives a second command from the first state machine indicating that the first command has remained the same for the first minimum time period, wherein the first portion of the module is configured to be powered from a battery via a first power supply voltage.

2. The circuit according to claim 1, wherein the first disable command corresponds to a first state of a first signal for controlling the module.

3. The circuit according to claim 2, wherein the first signal is configured to be obtained from a second signal for controlling the module and from a third signal indicating a state of a second power supply voltage of the module.

4. The circuit according to claim 2, wherein, when the first signal switches to the first state, the first state machine is configured to measure a time during which the first signal remains in the first state.

5. The circuit according to claim 1, wherein the second state machine is configured to electrically isolate the first portion of the module from of other circuits of the module upon reception of the second command.

6. The circuit according to claim 1, wherein the second state machine is configured to allow the power supply to provide power to a second portion of the module distinct from the first portion upon reception of the second command.

7. The circuit according to claim 1, wherein the first state machine is configured to provide the second command regardless of an operating state of the module.

8. The circuit according to claim 1, wherein the circuit further comprises a wake-up circuit configured to boot the module on reception of a boot command.

9. The circuit according to claim 8, wherein:
wherein the first disable command corresponds to a first state of a first signal for controlling the module; and
the circuit is configured to generate the boot command when the first signal of the module switches to a second state, different from the first state.

10. A method of powering an electronic module comprising a circuit for managing a power supply of the electronic module, the method comprising:
powering a first portion of the module with a first power supply voltage from a battery;
receiving, by a first state machine, a first command for disabling the module;
verifying, by the first state machine, that the first command remains the same for a first minimum time period;
receiving, by a second state machine, a second command from the first state machine indicating that the first command has remained the same for the first minimum time period; and
cutting off, by the second state machine, the power supply to the first portion of the module in response to receiving the second command.

11. The method according to claim 10, wherein the first disable command corresponds to a first state of a first signal for controlling the module.

12. The method according to claim 11, further comprising obtaining the first signal from a second signal for controlling the module and from a third signal indicating a state of a second power supply voltage of the module.

13. The method according to claim 11, further comprising when the first signal switches to the first state, counting, by the first state machine, a time during which the first signal remains in the first state.

14. The method according to claim 10, further comprising electrically isolating, by the second state machine, the first portion of the module from of other circuits of the module upon reception of the second command.

15. The method according to claim 10, further comprising allowing, by the second state machine, the power supply to provide power to a second portion of the module distinct from the first portion upon reception of the second command.

16. The method according to claim 10, wherein:
the first disable command corresponds to a first state of a first signal for controlling the module; and
the method further comprises
generating a boot command when the first signal of the module switches to a second state, different from the first state; and
booting the module using a wake-up circuit upon reception of the boot command.

17. An electronic module comprising:
a first circuit portion comprising an electronic circuit; and
a power supply management circuit comprising:
a first state machine configured to receive a first command for disabling the module, and to verify that the first command remains the same for a first minimum time period, and
a second state machine configured to cut off a power supply of the first circuit portion when the second state machine receives a second command from the first state machine indicating that the first command has remained the same for the first minimum time period, the first circuit portion being powered with a first power supply voltage from a battery.

18. The module according to claim 17, wherein the first circuit portion comprises a secure element.

19. The module according to claim 18, further comprising second circuit portion different from the first circuit portion, wherein the second circuit portion comprises a near-field communication circuit.

20. The module according to claim 17, further comprising the battery.
